(19) United States
(12) Patent Application Publication
(10) Pub. No.: US 2022/0065338 A1
(43) Pub. Date: Mar. 3, 2022

(54) DIFFERENTIAL DEVICE

(71) Applicant: MUSASHI SEIMITSU INDUSTRY CO., LTD., TOYOHASHI-SHI, AICHI (JP)

(72) Inventors: Toshiki KATO, TOYOHASHI-SHI, AICHI (JP); Hiroyuki MORI, TOYOHASHI-SHI, AICHI (JP); Yusuke SHINJO, TOYOHASHI-SHI, AICHI (JP)

(21) Appl. No.: 17/419,945

(22) PCT Filed: Jan. 21, 2020
(86) PCT No.: PCT/JP2020/001861

§ 371 Date: Jun. 30, 2021

(30) Foreign Application Priority Data
Jan. 22, 2019 (JP) 2019-008421

(51) Int. Cl. F16H 48/08; F16H 48/40

(52) U.S. Cl. CPC F16H 48/08; F16H 2048/087; F16H 48/40

(57) ABSTRACT

In a differential device in which a differential case has a pair of case half bodies that are mutually adjacently disposed in the axial direction, one case half body has a cutout part that extends in the axial direction while having one end opening on a face opposing the other case half body and that enables a shaft portion of a pinion shaft to be inserted thereinto, the other case half body has a support projecting portion that is fitted into the cutout part in the axial direction, and in an assembled state of the differential device in which the pair of case half bodies are joined to each other, the shaft portion of the pinion shaft inserted into the cutout part is held between the cutout part and the support projecting portion, and the pinion shaft is fixed to the differential case. Such differential device has easy assembly.

### TECHNICAL FIELD

The present invention relates to a differential device, and in particular to a differential device that includes a differential case that can rotate around a predetermined axis, a pair of side gears that are rotatably supported on the differential case, a pinion gear that meshes with the pair of side gears, and a pinion shaft that has a shaft portion in a direction orthogonal to an axial direction of the differential case and rotatably supports the pinion gear on the differential case via the shaft portion, the differential case having a pair of case half bodies that are mutually adjacently disposed and joined in the axial direction.

In the present invention and the present specification, ‘axial direction’, ‘peripheral direction’ and ‘radial direction’ mean axial direction, peripheral direction and radial direction with reference to the rotational axis of the differential case (that is, the predetermined axis) unless otherwise specified.

### BACKGROUND ART

With regard to such a differential device, a pinion shaft support structure in which one of case half bodies is provided with a cutout part that extends in the axial direction while having one end opening on a face opposing the other case half body and enabling a shaft portion of a pinion shaft to be inserted via the one end is conventionally known, as shown in for example Patent Document 1.

### PRIOR ART DOCUMENTS

### Patent Documents

Patent Document 1: Japanese Patent Application Laid-open No. 61-192948

### SUMMARY OF THE INVENTION

### Problems to be Solved by the Invention

Although the conventional differential device has the advantage that a differential gear mechanism can easily be assembled onto a differential case by for example inserting the shaft portion of the pinion shaft into the cutout part of the one case half body prior to joining the two case half bodies to each other, since the shaft portion of the pinion shaft can move in the axial direction within the cutout part even after the two case half bodies are joined to each other, there is the following inconvenience.

That is, in the differential device, when an imbalance occurs in the torque transmitted from a pinion gear to a pair of side gears due to differential rotation, the pinion gear is pushed toward the side gear on which the torque is small to thereby eliminate backlash, and there is a possibility that the pinion gear will interfere with a tooth face of the side gear, on which the torque is small, on the side opposite to a tooth face to which the torque is transmitted, thereby giving a rise to the problems that the durability of the gear will be degraded, the transmission noise will increase, etc.

The present invention has been proposed in light of the above circumstances, and it is an object thereof to provide a differential device that can solve the above problems by restricting movement of a shaft portion of a pinion shaft in the axial direction within a cutout part of a case half body in a state in which two case half bodies are joined to each other, and that has a simple structure and good ease of assembly.

### Means for Solving the Problems

In order to attain the above object, according to a first aspect of the present invention, there is provided a differential device comprising a differential case that can rotate around a predetermined axis, a pair of side gears that are rotatably supported on the differential case, a pinion gear that meshes with the pair of side gears, and a pinion shaft that has a shaft portion in a direction orthogonal to an axial direction of the differential case and rotatably supports the pinion gear on the differential case via the shaft portion, the differential case having a pair of case half bodies that are mutually adjacently disposed in the axial direction, characterized in that one case half body has a cutout part that extends in the axial direction while having one end opening on a face opposing the other case half body and that enables the shaft portion of the pinion shaft to be inserted thereinto, the other case half body has a support projecting portion that is fitted into the cutout part in the axial direction, and in an assembled state of the differential device in which the pair of case half bodies are joined to each other, the shaft portion of the pinion shaft inserted into the cutout part is held and fixed between the cutout part and the support projecting portion fitted into the cutout part.

Further, according to a second aspect of the present invention, in addition to the first aspect, the one case half body has a pinion gear support portion that slidably and rotatably supports a back face of the pinion gear, the support projecting portion is formed so as to be thinner than the pinion gear support portion in a radial direction of the differential case, and in the assembled state an oil reservoir space is defined between the back face of the pinion gear and the support projecting portion.

Furthermore, according to a third aspect of the present invention, in addition to the first or second aspect, mutually opposing faces between the support projecting portion and the shaft portion are each formed into a flat face and are in surface contact with each other.

Moreover, according to a fourth aspect of the present invention, in addition to any of the first to third aspects, the cutout part has a first cutout portion that extends in the axial direction while having one end opening on the opposing face, and a second cutout portion that extends in a peripheral direction of the one case half body from the other end of the first cutout portion, the shaft portion of the pinion shaft is inserted into the second cutout portion through the first cutout portion, and in the assembled state the shaft portion of the pinion shaft is held and fixed between the second cutout portion and the support projecting portion fitted into the first cutout portion.

### Effects of the Invention

In accordance with the first aspect of the present invention, since the one case half body has the cutout part, which extends in the axial direction while having one end opening on the face opposing the other case half body and enables the shaft portion of the pinion shaft to be inserted thereinto via the one end, the other case half body has the support projecting portion fitted into the cutout part in the axial direction, and in the assembled state of the differential device in which the two case half bodies are joined to each other, the shaft portion of the pinion shaft inserted into the cutout part is held between the cutout part and the support projecting portion fitted into the cutout part and is fixed to the differential case, it becomes possible to reliably restrict movement of the shaft portion of the pinion shaft in the axial direction within the cutout part by the support projecting portion. Moreover, when assembling the differential case by joining the pair of case half bodies to each other, since positioning of the two case half bodies in the peripheral direction can be easily and appropriately carried out merely by fitting the support projecting portion into the cutout part, the ease of assembly of the differential device can be enhanced. Furthermore, the support projecting portion, which is means for fixing the shaft portion of the pinion shaft, is also used as means for positioning the two case half bodies with respect to each other, thus accordingly contributing to simplification of the structure of the device and reduction in the cost.

Furthermore, in accordance with the second aspect, since the one case half body has the pinion gear support portion, which slidably and rotatably supports the back face of the pinion gear, the support projecting portion is formed so as to be thinner than the pinion gear support portion in the radial direction of the differential case, and the oil reservoir space is defined between the back face of the pinion gear and the support projecting portion, the oil reservoir space can be formed without difficulty between the support projecting portion and the back face of the pinion gear by regulating the thickness of the support projecting portion, and it is thereby possible to efficiently lubricate the back face of the pinion gear while simplifying the structure.

Moreover, in accordance with the third aspect, since the mutually opposing faces between the support projecting portion and the shaft portion are each formed into a flat face and are in surface contact with each other, it is possible to eliminate as much as possible the gap between the mutually opposing contact faces between the support projecting portion and the shaft portion, and it is thereby possible to suppress effectively lubricating oil flowing through to the outside of the differential case between the contact faces via the back face of the pinion gear.

Furthermore, in accordance with the fourth aspect, since the cutout part has the first cutout portion, which extends in the axial direction while having one end opening on the opposing face, and the second cutout portion, which extends in the peripheral direction from the other end of the first cutout portion, the shaft portion of the pinion shaft is inserted into the second cutout portion through the first cutout portion, and in the assembled state of the differential device the shaft portion of the pinion shaft is held and fixed between the second cutout portion and the support projecting portion fitted into the first cutout portion, it is possible to receive and restrict movement of the pinion shaft in the axial direction by means of one member (that is, an inner wall of the second cutout portion of the one case half body), and the support projecting portion can receive and restrict movement of the pinion shaft in the peripheral direction as a compressive load. Because of this, during transmission, there is no possibility that the force generated by the pinion shaft receiving a meshing reaction force or a transmission torque from the pinion gear and attempting to move in both the axial direction and the peripheral direction will affect a part where the two case half bodies are joined to each other, and the burden on the joined part can accordingly be alleviated.

### BRIEF DESCRIPTION OF DRAWINGS

FIG. 1 is an overall longitudinal sectional view (a sectional view along line 1-1 in FIG. 2) showing a differential device related to a first embodiment of the present invention. (first embodiment)

FIG. 2 is a sectional view along line 2-2 in FIG. 1. (first embodiment)

FIG. 3 is an enlarged sectional view along line 3-3 in FIG. 2. (first embodiment)

FIG. 4 is an exploded perspective view of the differential device related to the first embodiment. (first embodiment)

FIG. 5 is an enlarged sectional view of an essential part showing a differential device related to a second embodiment (a sectional view corresponding to an enlargement of part of FIG. 2). (second embodiment)

FIG. 6 is an enlarged sectional view along line 6-6 in FIG. 5 (a view corresponding to FIG. 3). (second embodiment)

FIG. 7 is an exploded perspective view of the differential device related to the second embodiment (illustration of a ring gear, a side gear and a side gear washer being omitted). (second embodiment)

### EXPLANATION OF REFERENCE NUMERALS AND SYMBOLS

C Differential case
C1 First case half body as one case half body
C2 Second case half body as other case half body
F2 Side face, on second case half body side, of extremity part of shaft portion as mutually opposing face
F3 Extremity face of supporting projection part as mutually opposing face
F2′ Side face, on supporting projection part side, of shaft portion as mutually opposing face
F3′ Cut face of side face, on shaft portion side, of supporting projection part as mutually opposing face
K, K′ Cutout part
K1 First cutout portion
K2 Second cutout portion
Ko One end
X1 First axis as predetermined axis
XL Imaginary straight line
10 Differential device
21, 22 First and second side gears as pair of side gears
23 Pinion gear
24 Pinion shaft
24a Shaft portion of pinion shaft
32t, 32t′ Support projecting portion
33a Peripheral wall portion as pinion gear support portion
50 Oil reservoir space

### MODES FOR CARRYING OUT THE INVENTION

Embodiments of the present invention are explained below by reference to the attached drawings.

### First Embodiment

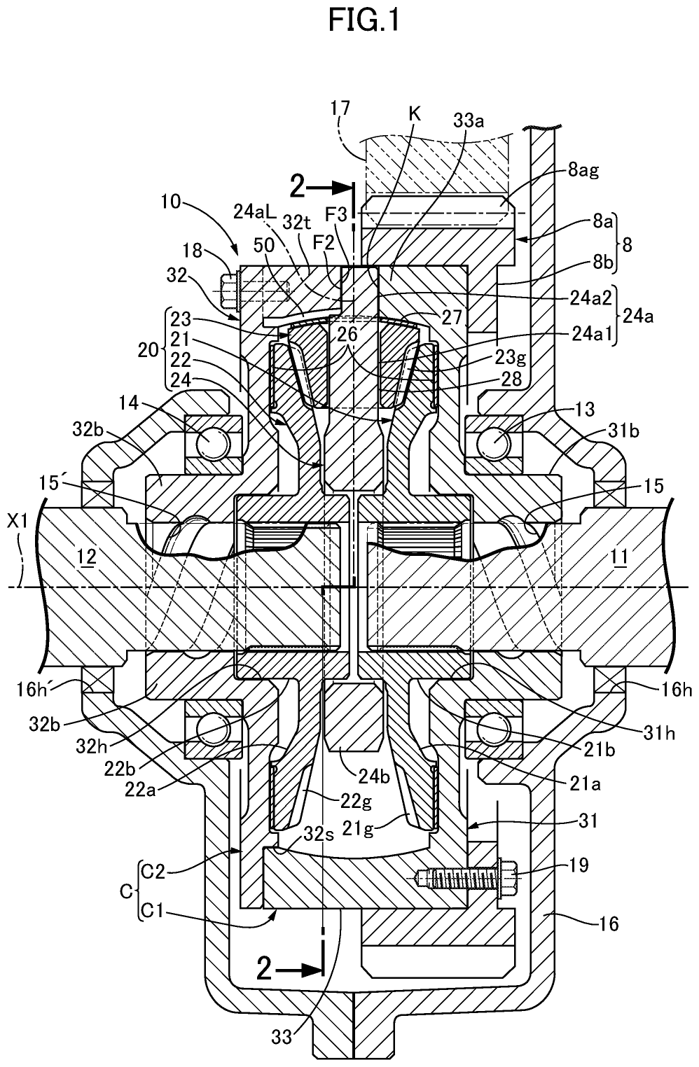

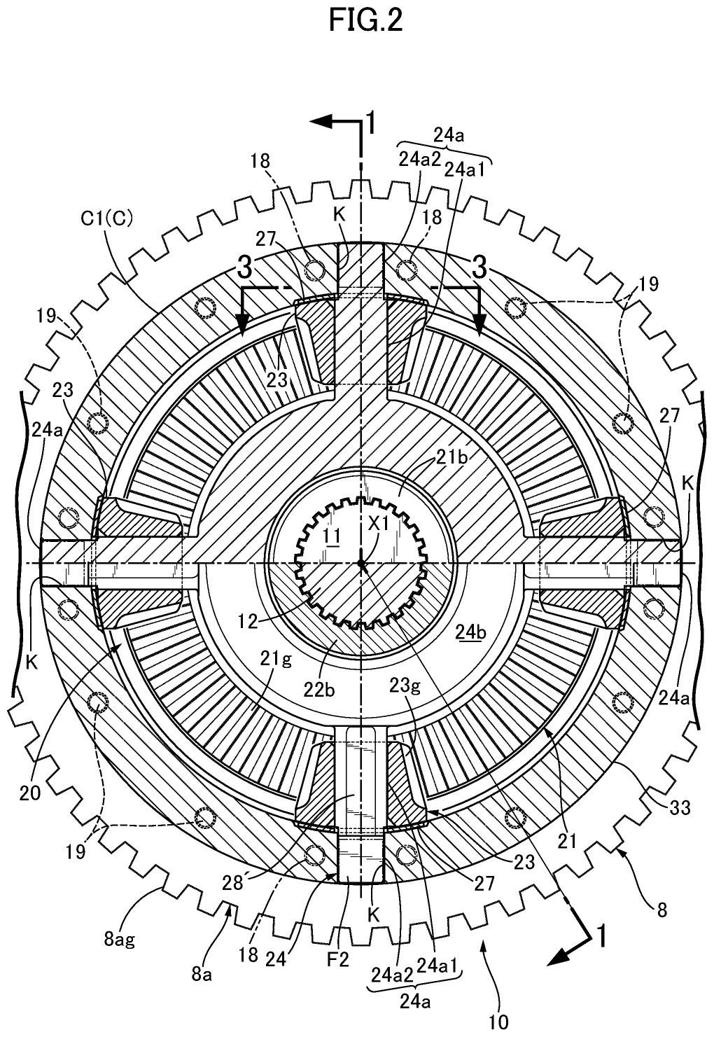

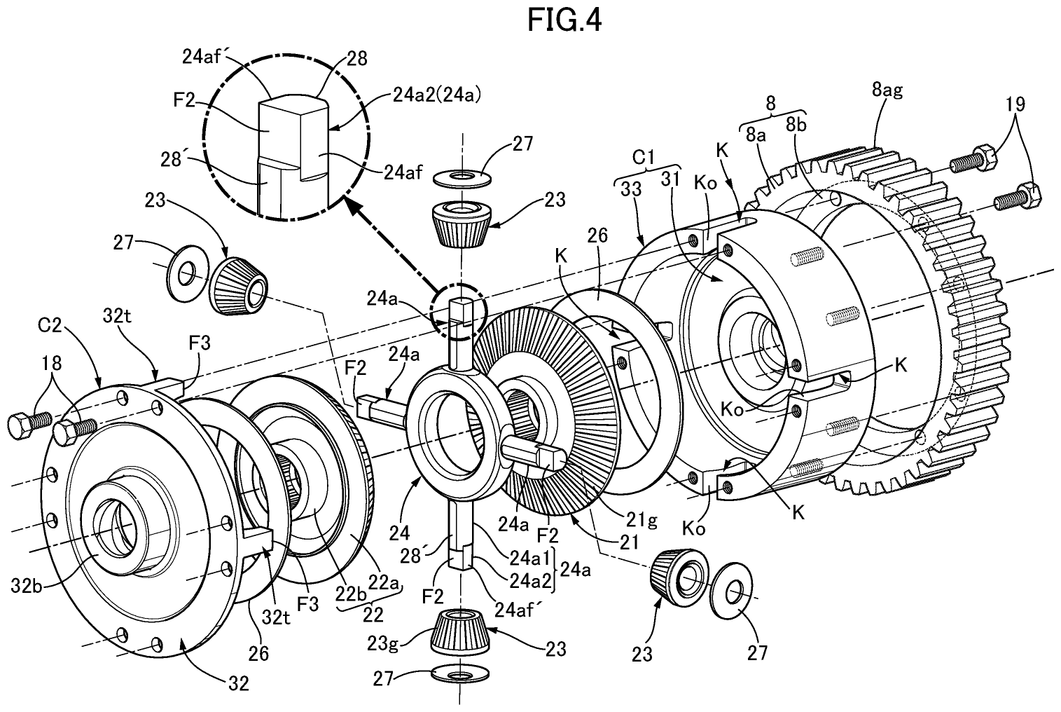

First, a first embodiment is explained by reference to FIG. 1 to FIG. 4. In FIG. 1, housed within a transmission case 16 of a vehicle (for example, an automobile) is a differential device 10 that distributes and transmits power from a power source (for example, a vehicle-mounted engine), which is not illustrated, between left and right axles 11, 12 as drive shafts. The differential device 10 includes a differential case C and a differential mechanism 20 provided within the differential case C.

Disposed within the transmission case 16 is a drive gear 17 that is coupled to the power source via a speed change device, which is not illustrated. A ring gear 8 meshing with the drive gear 17 is fixed to the differential case C with a mounting structure, which is described later. An annular seal member is disposed between each of through holes 16h, 16h′ provided in the transmission case 16 and the left and right axles 11, 12 inserted into the holes 16h, 16h′.

The differential case C is formed by detachably joining to each other first and second case half bodies C1, C2 that are mutually adjacently disposed in the axial direction, via a plurality of bolts 18 arranged at intervals in the peripheral direction, and is supported on the transmission case 16 so that it can rotate around a first axis X1 as a predetermined axis.

The first case half body C1 is formed into a bottomed cylindrical shape while including a disk-shaped first end wall part 31 having a circular hole 31h in its center part and a cylindrical peripheral wall part 33 connectedly provided integrally with the outer periphery of the first end wall part 31. On the other hand, the second case half body C2 has as a main body a disk-shaped second end wall part 32 having a circular hole 32h in its center part, and a step portion 32s onto which an extremity part of the peripheral wall part 33 of the first case half body C1 is concentrically fitted is formed on an inside face of the second end wall part 32. The second case half body C2 blocks an open end of the first case half body C1 in a state in which it is joined to the first case half body C1.

First and second bearing bosses 31b, 32b coaxially facing opposite directions from each other on the first axis X1 are connectedly provided integrally with outside faces of the first and second end wall parts 31, 32 respectively, and inner peripheral faces of the bearing bosses 31b, 32b are continuous via a step part from the circular holes 31h, 32h of the corresponding first and second end wall parts 31, 32. The first and second bearing bosses 31b, 32b are supported on the transmission case 16 via bearings 13, 14 on the outer peripheral side so that they can rotate around the first axis X1.

The left and right axles 11, 12 are rotatably fitted into inner peripheral faces of the first and second bearing bosses 31b, 32b respectively, and helical grooves 15, 15′ (see FIG. 1) for drawing in lubricating oil are provided in the inner peripheral faces. Each of the helical grooves 15, 15′ can exhibit a screw pump function via which lubricating oil within the transmission case 16 is fed into the differential case C accompanying relative rotation between the bearing bosses 31b, 32b and the axles 11, 12, and forms means for introducing lubricating oil into the differential case C.

With regard to the first and second case half bodies C1, C2, mutually opposing faces between an end face of the peripheral wall part 33 of the former and an outer peripheral part of the inside face of the second end wall part 32 of the latter (more specifically, an inside face further radially outside than the annular step portion 32s) are mutually mating faces of the case half bodies C1, C2. The bolt 18 extends through the second case half body C2 at a position where it extends through the mating faces and is screwed into and secured to the first case half body C1.

In the present embodiment, the ring gear 8 includes a rim portion 8a having a helical gear-shaped tooth portion Bag on the outer periphery, and a ring plate-shaped spoke portion 8b integrally protruding from an inner peripheral face of the rim portion 8a. In FIG. 1 the tooth portion Bag is illustrated in a cross section along the line of teeth for simplification.

The ring gear 8 is fixed to the first case half body C1 by screwing a plurality of bolts 19 extending through the spoke portion 8b into the first case half body C1 in a state in which one side face of the spoke portion 8b and the inner peripheral face of the rim portion 8a are abutted against an outer end face and an outer peripheral face of the first case half body C1. Means for fixing the ring gear 8 to the differential case C is not limited to that in the embodiment; for example, welding, swaging, etc. may be employed, or alternatively the ring gear 8 may be fixed to the second case half body C2.

One example of the differential mechanism 20 is now explained. The differential mechanism 20 includes first and second side gears 21, 22 supported on the first and second case half bodies C1, C2 so that they can rotate around the first axis X1, a plurality of pinion gears 23 meshing with the two side gears 21, 22, and a pinion shaft 24 supported on the differential case C while having a plurality of shaft portions 24a fittingly supporting the pinion gears 23.

The first and second side gears 21, 22 have cylindrical boss portions 21b, 22b and disk-shaped side gear main body portions 21a, 22a connectedly provided integrally with and extending outward in the radial direction from the outer periphery of the boss portions 21b, 22b (and consequently flattened in the axial direction).

With regard to the first and second side gears 21, 22, outer peripheries of outer end parts of the cylindrical boss portions 21b, 22b are fitted and supported on the first and second case half bodies C1, C2 (more specifically, the circular holes 31h, 32h of the first and second end wall parts 31, 32) so that they can rotate around the first axis X1. Inner end parts of the left and right axles 11, 12 are fitted (e.g. spline fitted) into inner peripheral faces of the cylindrical boss portions 21b, 22b so that they can slide in the axial direction but cannot undergo relative rotation.

On the other hand, gear portions 21g, 22g, which are bevel gears, are provided on inside faces of outer peripheral parts of the side gear main body portions 21a, 22a, and outside faces (that is, back faces) of the outer peripheral parts of the side gear main body portions 21a, 22a are each rotatably and slidably abutted against and supported on inside faces of the first and second case half bodies C1, C2 (more specifically, the first and second end wall parts 31, 32) via side gear washers 26.

The plurality of shaft portions 24a of the pinion shaft 24 each have an axis that extends radially while being perpendicular to the first axis X1, and the inner ends thereof are integrally joined to a substantially annular ring body 24b having its center on the first axis X1. The number of shaft portions 24a (and consequently pinion gears 23) is four in the embodiment, but it may be appropriately selected (for example, two, three, five or more), and they are disposed at equal intervals in the peripheral direction. The pinion shaft 24 may not include the ring body 24b, and the mode in which the shaft portions 24a are joined to each other is not limited to that of the embodiment. For example, the shaft portions 24a may be joined directly to each other or alternatively they may be linked via a linking body other than a ring body.

Each shaft portion 24a is formed into a basically columnar shape in the present embodiment, and has a base portion 24a1 and an extremity portion 24a2 that can be inserted into a cutout part K, which is described later, the pinion gear 23 being fitted to and supported on the base portion 24a1 so that it can rotate and slide in the axial direction of the shaft portion 24a. A pair of flat cut faces 28, 28′ arranged in the axial direction of the differential case C are formed on an outer peripheral face of the shaft portion 24a of the present embodiment, and a flat oil hole is defined between the cut faces 28, 28′ and an inner peripheral face of the pinion gear 23, the oil hole allowing lubricating oil to flow. The cut faces 28, 28′ may be omitted.

Each pinion gear 23 has on its outer periphery a gear portion 23g, which is a bevel gear, and a back face of each pinion gear 23 is rotatably supported on the peripheral wall part 33 of the first case half body C1 via a conically-tapered pinion washer 27. A peripheral wall portion 33a, supporting the back face of the pinion gear 23, of the peripheral wall part 33 is a pinion gear-supporting part.

The shaft portion 24a of the pinion shaft 24 is axially non-movably and relatively non-rotatably supported on a peripheral wall of the differential case C (more specifically, the peripheral wall part 33 of the first case half body C1) in a state in which it is set in the differential case C. The rotational driving force transmitted from the ring gear 8 to the differential case C is distributed and transmitted between the left and right axles 11, 12 via the differential mechanism 20 while allowing differential rotation. Such a power distribution function of the differential mechanism 20 is conventionally known, and further explanation is therefore omitted.

One example of the structure via which the pinion shaft 24 is mounted and fixed to the differential case C is now specifically explained by reference to FIGS. 1, 3 and 4 in particular.

Formed in the first case half body C1, and in particular the peripheral wall part 33, at equal intervals in the peripheral direction are a plurality (that is, the same number as that of the pinion gears 23) of cutout parts K extending in the axial direction of the differential case C so as to have one end Ko opening on a face opposing the second case half body C2 (that is, the end face of the peripheral wall part 33). In a state prior to assembly in which the first case half body C1 is detached from the second case half body C2, the extremity portion 24a2 of the shaft portion 24a of the pinion shaft 24 can be inserted into the respective cutout part K in the axial direction via the one end Ko. Each cutout part K is formed so as to have a width that enables the extremity portion 24a2 of the shaft portion 24a of the pinion shaft 24 to slide, that is, it is substantially the same width as that of the extremity portion 24a2.

On the other hand, a support projecting portion 32t is projectingly provided integrally with a face, opposing the first case half body C1, of the second case half body C2 (more specifically the outer peripheral part of the inside face of the second end wall part 32), the support projecting portion 32t being formed into a rod shape having a rectangular cross section extending in the axial direction of the differential case C and being capable of being fitted into the cutout part K in the axial direction. In an assembled state of the differential device 10 in which the two case half bodies C1, C2 are joined to each other, the differential device 10 is fixed to the differential case C by the shaft portion 24a of the pinion shaft 24 inserted into the cutout part K, and in particular the extremity portion 24a2, being held in the axial direction between the cutout part K and the support projecting portion 32t fitted thereinto.

Mutually opposing faces F3, F2 between the support projecting portion 32t and the shaft portion 24a (more specifically, an extremity face F3 of the support projecting portion 32t and a side face F2, on the second case half body C2 side, of the extremity portion 24a2 of the shaft portion 24a) are each formed into a flat face (in the embodiment a flat face orthogonal to the first axis X1), and in the assembled state of the differential device 10 they are in a surface contact state. The shaft portion 24a is thereby axially relatively non-movably fixed to the differential case C.

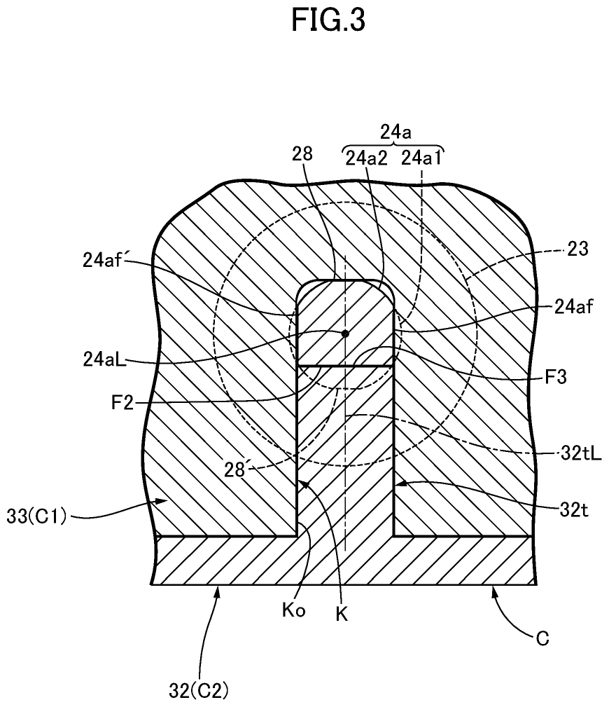

As clearly shown in FIG. 3, in the peripheral direction of the differential case C, the shaft portion 24a, in particular one side face 24af and the other side face 24af of the extremity portion 24a2, are cut into flat faces that are parallel to each other, and are in respective surface contact with two inside faces, opposing each other in the peripheral direction, of the cutout part K. The shaft portion 24a, that is, the pinion shaft 24, is thereby reliably prevented from rotating with respect to the differential case C, and torque is therefore reliably transmitted from the differential case C to the pinion shaft 24 without backlash.

As clearly shown in FIG. 1, with regard to the support projecting portion 32t, at least a face thereof opposing a back face of the pinion gear 23 (that is, the pinion gear washer 27) is set back to the outside in the radial direction of the differential case C, and it is formed thinner in the radial direction than the peripheral wall part 33 of the first case half body C1 (more specifically, the peripheral wall portion 33a, which is a pinion gear-supporting part). In the assembled state of the differential device 10, a flat oil reservoir space 50 is therefore defined between opposing faces of the back face of the pinion gear 23 (that is, the pinion gear washer 27) and the support projecting portion 32t so as to follow the support projecting portion 32t.

The operation of the embodiment is now explained.

When assembling the differential device 10, in a state in which the first and second case half bodies C1, C2 are separated from each other, for example, the side gear washer 26 and the first side gear 21 are first set within the first case half body C1. Subsequently, in order to set the pinion shaft 24, which has the pinion gear 23 and the pinion gear washer 27 fitted to the base portion 24a1 of each of the shaft portions 24a, in the first case half body C1, the extremity portion 24a2 of each of the shaft portions 24a is inserted into the respective cutout part K in the axial direction of the differential case C via the opening of the one end Ko.

The second side gear 22 having the side gear washer 26 disposed on its back face is then meshed with the pinion gear 23 and, furthermore, while carrying out positioning in the peripheral direction by fitting each support projecting portion 32t of the second case half body C2 into the respective cutout part K, the second case half body C2 (more specifically, the outer peripheral part of the inside face of the second end wall part 32) is abutted against the first case half body C1 (more specifically, the end face of the peripheral wall part 33). In the abutted state, an extremity part of the peripheral wall part 33 of the first case half body C1 is concentrically fitted onto the annular step portion 32s of the inside face of the second case half body C2, and the two case half bodies C1, C2 are joined to each other and integrated by means of the plurality of bolts 18. In this process, the inside face of the second end wall part 32 of the second case half body C2 supports the back face of the second side gear 22 via the side gear washer 26.

When assembly of the differential device 10 is completed in this way, the spoke portion 8b of the ring gear 8 is fitted to the first case half body C1, and the two are integrally joined by means of the plurality of bolts 19. In addition, the ring gear 8 may be fixed to the first case half body C1 in advance, and following this the differential device 10 may be assembled.

The first and second bearing bosses 31b, 32b of the differential case C after completion of assembly are rotatably supported on the transmission case 16 via the bearings 13, 14 and, furthermore, inner end parts of the left and right axles 11, 12 are fitted into the first and second bearing bosses 31b, 32b and spline fitted into inner peripheries of the first and second side gears 21, 22, thereby completing an operation of assembling the differential device 10 onto the automobile.

When the differential device 10 exhibits a differential function, the left and right bearing bosses 31b, 32b of the differential case C and the axles 11, 12 undergo relative rotation, and accompanying this the helical grooves 15, 15′ in the inner periphery of the bearing bosses 31b, 32b exhibit a screw pump function of feeding lubricating oil scattered within the transmission case 16 into the differential case C. This enables lubricating oil outside the differential case C to be introduced into each part of the differential mechanism 20 within the differential case C even without a large window hole being present in the differential case C.

In this case, for example, considerable lubricating oil that has reached the back face side of the pinion gear 23 builds up in the oil reservoir space 50 defined between the opposing faces of the back face of the pinion gear 23 (that is, the pinion gear washer 27) and the support projecting portion 32t, and a rotationally-sliding part between the pinion gear 23 back face side and the peripheral wall portion 33a as a pinion gear-supporting part of the differential case C can be lubricated efficiently.

In accordance with the first embodiment explained above, the first case half body C1 has the cutout part K, which extends in the axial direction while having the one end Ko opening on the face opposing the second case half body C2 and enables the shaft portion 24a of the pinion shaft 24 to be inserted thereinto via the one end Ko, whereas the second case half body C2 has the support projecting portion 32t fitted into the cutout part K in the axial direction, and in the assembled state of the differential device 10 in which the two case half bodies C1, C2 are joined to each other, the shaft portion 24a inserted into the cutout part K is held in the axial direction between the cutout part K and the support projecting portion 32t fitted into the cutout part K and is fixed to the differential case C.

This enables movement of the shaft portion 24a of the pinion shaft 24 in the axial direction within the cutout part K to be reliably restricted by the support projecting portion 32t. Because of this, for example, even if imbalance occurs in the torque transmitted from the pinion gear 23 to the first and second side gears 21, 22 due to differential rotation of the differential device 10, the first and second side gears 21, 22 and the pinion gear 23 are each meshed appropriately, thus enabling improvement of the durability of each of the gears and a reduction in transmission noise to be achieved.

Furthermore, in the assembled state, since movement in the peripheral direction of the shaft portion 24a of the pinion shaft 24 within the cutout part K can be reliably restricted due to the two side faces 24af, 24af of the shaft portion 24a abutting against the two mutually opposing inside faces of the cutout part K, the pinion shaft 24 rotates integrally with the differential case C without backlash in the peripheral direction, and variation occurring in the torque transmitted by the differential device 10 can be suppressed.

Moreover, when assembling the differential case C by joining the first and second case half bodies C1, C2 to each other, since positioning of the two case half bodies C1, C2 in the peripheral direction can be easily and appropriately carried out merely by fitting the support projecting portion 32t into the cutout part K, the ease of assembly of the differential device 10 can be enhanced. Furthermore, since the support projecting portion 32t, which is means for fixing the pinion shaft 24 to the differential case C, is also used as means for positioning the two case half bodies C1, C2 with respect to each other, the structure of the device can be simplified accordingly, and cost can be saved. When the number of support projecting portions 32t is three or greater, it is possible, by decreasing the machining tolerance, to carry out not only positioning in the peripheral direction between the first and second case half bodies C1, C2 but also positioning in the radial direction position, thus enabling centering to be achieved.

The support projecting portion 32t of the present embodiment is formed so as to be thinner in the radial direction than the peripheral wall portion 33a, which is the pinion gear-supporting part of the differential case C, and the oil reservoir space 50 is defined between the back face of the pinion gear 23 (that is, the pinion gear washer 27) and the support projecting portion 32t. Since the oil reservoir space 50 can be formed without difficulty on the back face side of the pinion gear 23 by utilizing the support projecting portion 32t and regulating the thickness of the support projecting portion 32t, it is possible to efficiently lubricate the back face side of the pinion gear 23 while simplifying the structure.

In the present embodiment, since the mutually opposing faces F3, F2 between the support projecting portion 32t and the shaft portion 24a (in particular, the extremity portion 24a2) are each formed into a flat face and are in surface contact with each other, it is possible to eliminate as much as possible the gap between the contact faces of the mutually opposing faces F3, F2 of the support projecting portion 32t and the shaft portion 24a. It is thereby possible to suppress effectively lubricating oil flowing through to the outside of the differential case C between the contact faces via the back face side of the pinion gear 23.

### Second Embodiment

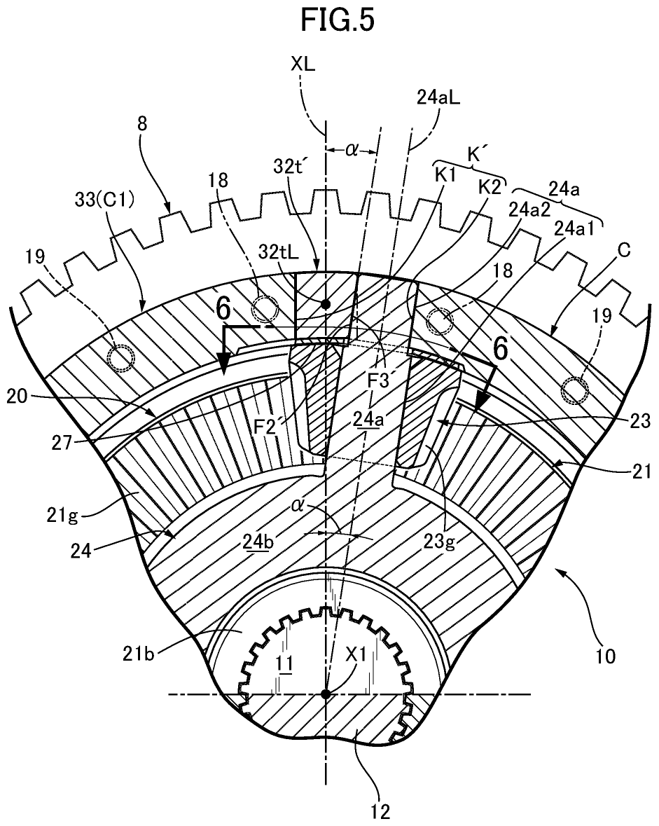

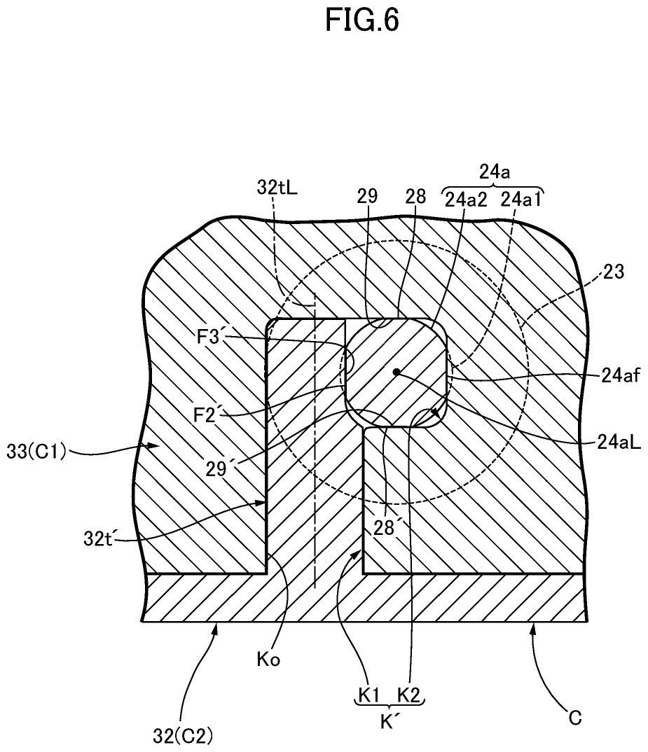

A second embodiment is now explained by reference to FIG. 5 to FIG. 7. The first embodiment illustrates an arrangement in which the cutout part K provided in the peripheral wall part 33 of the first case half body C1 is formed into a linear shape in the axial direction, and the shaft portion 24a of the pinion shaft 24 is held in the axial direction between the support projecting portion 32t and an inner deep part of the cutout part K. On the other hand, in the second embodiment, a cutout part K′ provided in the peripheral wall part 33 of the first case half body C1 has a substantially L-shaped form while having a first cutout portion K1 that extends in the axial direction while having one end Ko opening on a face, opposing the second case half body C2, of the first case half body C1, and a second cutout portion K2 that extends toward one side in the peripheral direction of the first case half body C1 from the other end of the first cutout portion K1, the shaft portion 24a of the pinion shaft 24 (in particular, the extremity portion 24a2) being inserted and fitted into the second cutout portion K2 through the first cutout portion K1.

In the assembled state of the differential device 10, the extremity portion 24a2 of the shaft portion 24a of the pinion shaft 24 is held in the peripheral direction between a support projecting portion 32t′ fitted into the first cutout portion K1 and a flat inner end face of the second cutout portion K2. At the same time, the extremity portion 24a2 of the shaft portion 24a is held in the axial direction between flat inside faces 29, 29′ on one side and the other side in the axial direction of the second cutout portion K2 while putting a pair of cut faces 28, 28′ thereof into surface contact with the two inside faces 29, 29′ respectively. In this way, the pinion shaft 24 is fixed in both the peripheral direction and the axial direction with respect to the differential case C.

Furthermore, the support projecting portion 32t′ and the shaft portion 24a of the pinion shaft 24 have central axes 32tL, 24aL thereof offset from each other toward one side in the peripheral direction in the assembled state of the differential device 10, and when viewed in a cross section passing through the central axis 24aL of the shaft portion 24a and orthogonal to the first axis X1 (see FIG. 5), the shaft portion 24a is inclined at a predetermined angle a with respect to an imaginary straight line XL joining the first axis X1 and the central axis 32tL of the support projecting portion 32t′ due to the offset.

Mutually opposing faces F3′, F2′ of the support projecting portion 32t′ and the shaft portion 24a (more specifically, a flat cut face F3′ formed by indenting part of a side face, on the shaft portion 24a side, of the support projecting portion 32t′, and a side face F2′, on the support projecting portion 32t′ side, of the shaft portion 24a) are each formed into a flat face that is inclined at the predetermined angle α with respect to the imaginary straight line XL due to the inclined attitude when viewed in the cross section, and are in surface contact with each other.

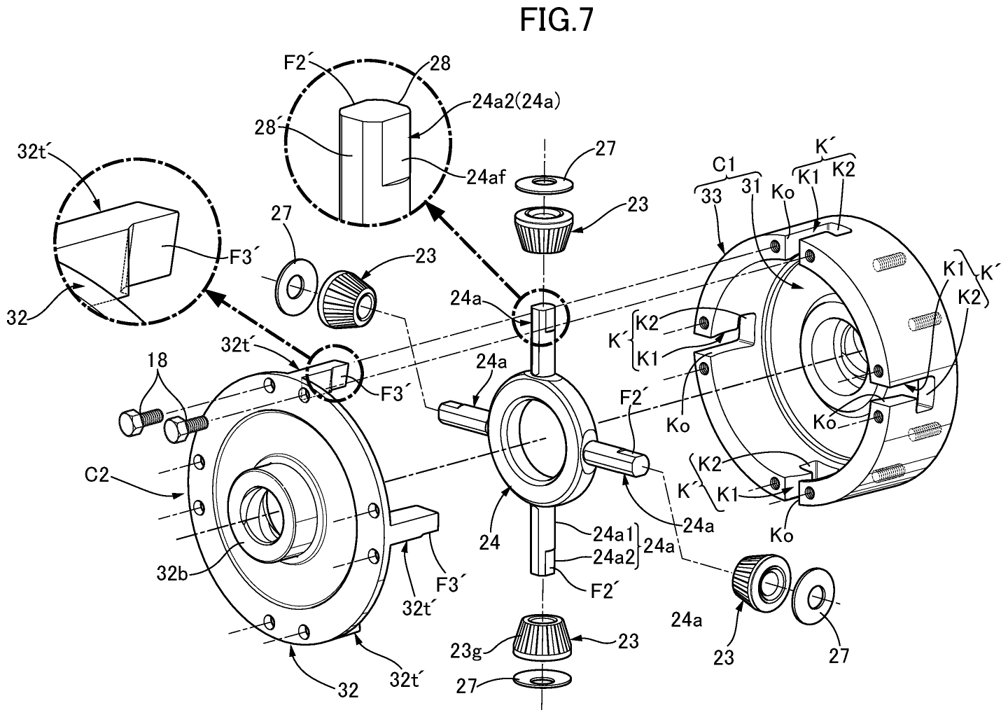

The arrangement of the second embodiment is otherwise the same as that of the first embodiment; constituent elements are denoted by the same reference numerals and symbols as those of the corresponding constituent elements of the first embodiment, further explanation thereof being omitted. In an exploded perspective view of FIG. 7, illustration of the ring gear 8, the side gears 21, 22, and the side gear washer 26 is omitted, but these components 8, 21, 22, 26 are also disposed in the second embodiment in the same manner as in the first embodiment. The second embodiment thereby achieves basically the same operational effects as in the first embodiment.

Furthermore, in accordance with the second embodiment, since the cutout part K has the substantially L-shaped form while having the first cutout portion K1 and the second cutout portion K2 extending toward one side in the peripheral direction from the inner end of the first cutout portion K1, and the shaft portion 24a of the pinion shaft 24 inserted into the second cutout portion K2 through the first cutout portion K1 is held and fixed between the second cutout portion K2 and the support projecting portion 32t′ fitted into the first cutout portion K1, it is possible to receive and restrict movement of the shaft portion 24a in the axial direction by means of one member (that is, an inner wall of the second cutout portion K2 of the first case half body C1), and the support projecting portion 32t′ can firmly receive and restrict movement of the shaft portion 24a of the pinion shaft 24 in the peripheral direction as a compressive load.

As a result, during transmission in the differential device 10, there is no possibility that the force generated by the pinion shaft 24 receiving a meshing reaction force or a transmission torque from the pinion gear 23 and attempting to move in both the axial direction and the peripheral direction will affect a part where the case half bodies C1, C2 are joined to each other (the bolt 18 and the peripheral part thereof), and the burden on the joined part is accordingly alleviated.

Moreover, since the support projecting portion 32t′ and the shaft portion 24a of the pinion shaft 24 have the central axes 32tL, 24aL thereof offset from each other in the peripheral direction in the assembled state, when viewed in a cross section passing through the central axis 24aL of the shaft portion 24a and orthogonal to the first axis X1 (see FIG. 5) the shaft portion 24a is inclined with respect to the imaginary straight line XL joining the first axis X1 and the central axis 32tL of the support projecting portion 32t′ due to the offset, and the mutually opposing faces F3′, F2′ of the support projecting portion 32t′ and the shaft portion 24a are each formed into a flat face inclined with respect to the imaginary straight line XL due to the inclined attitude when viewed in the cross section and are in surface contact with each other, not only is it possible to contribute to a reduction in backlash of the contact part, but it is also possible to reduce the contact surface pressure because the contact area between the mutually opposing faces F3′, F2′ increases by a portion corresponding to the inclination.

Embodiments of the present invention are explained above, but the present invention is not limited to the embodiments and may be modified in a variety of ways as long as the modifications do not depart from the subject matter.

For example, the embodiments illustrate a case in which the differential device 10 is implemented in a vehicular differential device, but in the present invention the differential device 10 may be implemented in various types of machines and devices other than a vehicle.

Furthermore, the embodiments illustrate a case in which the tooth portion 8ag of the ring gear 8 has a helical gear shape, but the ring gear of the present invention is not limited to that of the embodiments and may be, for example, a bevel gear, a hypoid gear, a spur gear, etc.

Moreover, the embodiments illustrate a case in which the first and second case half bodies C1, C2 are joined to each other by the plurality of bolts 18, but the joining means is not limited to that of the embodiments, and various joining means (for example, welding, swaging, etc.) may be employed.

Furthermore, the embodiments illustrate a case in which the side gear washer 26 is disposed on the back faces of the side gears 21, 22 and the pinion gear washer 27 is disposed on the back face of the pinion gear 23, but at least one of the washers 26, 27 may be omitted, and the back face of the side gears 21, 22 and/or the back face of the pinion gear 23 may be supported directly on the inner face of the differential case C.

Moreover, the embodiments illustrate as one example of the lubricating oil introduction means the helical grooves 15, 15′ for drawing in lubricating oil, which are provided in the inner peripheral faces of the bearing bosses 31b, 32b, but the lubricating oil introduction means is not limited to that of the embodiments. For example, instead of or in addition to the helical grooves 15, 15′, a lubricating oil passage or a helical groove may be provided as the lubricating oil introduction means in the axles 11, 12 or a boss of the side gears 21, 22 formed by extending lengthwise the back face of the side gear 23 so as to extend outside the differential case C, etc.

Furthermore, the embodiments illustrate a case in which the peripheral wall part 33 of the differential case C and the first and second end wall parts 31, 32 are not provided with an oil access window, but an oil access window may be provided as necessary in the peripheral wall part 33 of the differential case C and the first and second end wall parts 31, 32.

Moreover, the embodiments illustrate a case in which the ring gear 8 is joined to the differential case C as means for inputting power from a power source to the differential case C, but the power input means is not limited to that of the embodiments, and for example instead of the ring gear 8 various transmission wheels (for example, a sprocket, a V pulley, etc.) may be used. Alternatively, an output member of various speed decrease or speed increase devices (for example, a carrier of a planetary gear device, etc.) may be joined to the differential case C (for example, the first case half body C1 or the second case half body C2), or may be formed integrally therewith.

In addition, when the number of the plurality of shaft portions 24a is two, that is, the pinion shaft 24 has a linear shape, the pinion shaft 24 has a structure that allows not only movement in the axial direction but also movement in the radial direction (that is, the axial direction of the pinion shaft 24), and it is therefore necessary to restrict movement in the axial direction of the pinion shaft 24 and prevent the pinion shaft 24 from falling out of the differential case C. In this case, although not illustrated, for example, the prevention of the pinion shaft 24 falling out can be carried out by providing the support projecting portion 32t with an extension covering an end face of the shaft portion 24a in the radial direction. Alternatively, the prevention of the pinion shaft 24 falling out may be carried out by mounting on an end face of the support projecting portion 32 in the axial direction a shaft-shaped member such as a roller pin protruding from the end face, providing the shaft portion 24a of the pinion shaft 24 with a hole part, and inserting the shaft-shaped member into the hole part. Alternatively, the prevention of the pinion shaft 24 falling out may be carried out by indenting radially inwardly parts of the support projecting portion 32t and the differential case outer peripheral side of the cutout part K around the shaft portion 24a, making the shaft portion 24a protrude into the indented portion, and engaging with the shaft portion 24a a latching member such as a circlip latched onto the inner periphery of the indented portion.

1. A differential device comprising a differential case that can rotate around a predetermined axis, a pair of side gears that are rotatably supported on the differential case, a pinion gear that meshes with the pair of side gears, and a pinion shaft that has a shaft portion in a direction orthogonal to an axial direction of the differential case and rotatably supports the pinion gear on the differential case via the shaft portion, the differential case having a pair of case half bodies that are mutually adjacently disposed in the axial direction,
wherein one case half body has a cutout part that extends in the axial direction while having one end opening on a face opposing the other case half body and that enables the shaft portion of the pinion shaft to be inserted thereinto,
said other case half body has a support projecting portion that is fitted into the cutout part in the axial direction, and
in an assembled state of the differential device in which the pair of case half bodies are joined to each other, the shaft portion of the pinion shaft inserted into the cutout part is held and fixed between the cutout part and the support projecting portion fitted into the cutout part.

2. The differential device according to claim 1, wherein said one case half body has a pinion gear support portion that slidably and rotatably supports a back face of the pinion gear,
the support projecting portion is formed so as to be thinner than the pinion gear support portion in a radial direction of the differential case, and in the assembled state an oil reservoir space is defined between the back face of the pinion gear and the support projecting portion.

3. The differential device according to claim 1, wherein mutually opposing faces between the support projecting portion and the shaft portion are each formed into a flat face and are in surface contact with each other.

4. The differential device according to claim 1, wherein the cutout part has a first cutout portion that extends in the axial direction while having one end opening on the opposing face, and a second cutout portion that extends in a peripheral direction of said one case half body from the other end of the first cutout portion,
the shaft portion of the pinion shaft is inserted into the second cutout portion through the first cutout portion, and
in the assembled state the shaft portion of the pinion shaft is held and fixed between the second cutout portion and the support projecting portion fitted into the first cutout portion.

5. The differential device according to claim 2, wherein mutually opposing faces between the support projecting portion and the shaft portion are each formed into a flat face and are in surface contact with each other.

6. The differential device according to claim 2, wherein the cutout part has a first cutout portion that extends in the axial direction while having one end opening on the opposing face, and a second cutout portion that extends in a peripheral direction of said one case half body from the other end of the first cutout portion,
the shaft portion of the pinion shaft is inserted into the second cutout portion through the first cutout portion, and
in the assembled state the shaft portion of the pinion shaft is held and fixed between the second cutout portion and the support projecting portion fitted into the first cutout portion.

7. The differential device according to claim 3, wherein the cutout part has a first cutout portion that extends in the axial direction while having one end opening on the opposing face, and a second cutout portion that extends in a peripheral direction of said one case half body from the other end of the first cutout portion,
the shaft portion of the pinion shaft is inserted into the second cutout portion through the first cutout portion, and
in the assembled state the shaft portion of the pinion shaft is held and fixed between the second cutout portion and the support projecting portion fitted into the first cutout portion.

8. The differential device according to claim 5, wherein the cutout part has a first cutout portion that extends in the axial direction while having one end opening on the opposing face, and a second cutout portion that extends in a peripheral direction of said one case half body from the other end of the first cutout portion,
the shaft portion of the pinion shaft is inserted into the second cutout portion through the first cutout portion, and
in the assembled state the shaft portion of the pinion shaft is held and fixed between the second cutout portion and the support projecting portion fitted into the first cutout portion.
